(19) United States
(12) Patent Application Publication
(10) Pub. No.: US 2005/0132673 A1
(43) Pub. Date: Jun. 23, 2005

(54) Remote controlled bucking system

(76) Inventor: Norman John Humiston JR., Schuylerville, NY (US)

Correspondence Address: Kristen L. Ashdown, Esq., 127 Pearl Street, Schuylerville, NY, 12871, US

(21) Appl. No.: 10/741,656

(22) Filed: Dec. 19, 2003

(51) Int. Cl. B68B 1/00

(52) U.S. Cl. 54/1

(57) ABSTRACT

A remote controlled bucking system comprising a remote controlled bucking strap and a remote controlled hand strap, releasable from a remote location.

### BACKGROUND OF THE INVENTION

1. Technical Field

The present invention relates generally to a bucking system, and more specifically, to a remote controlled bucking system capable of releasing a bucking strap and/or a hand strap.

2. Related Art

During a rodeo or other similar event, a bucking strap is fastened around the hindquarters of an animal, e.g., a horse, bull, or other livestock, to make the animal buck. A hand strap may be secured around the front portion of the animal, just behind the front legs of the animal, to give the rider something to hold onto during the ride. The rider fastens the free end of the hand strap around his/her hand helping to secure the rider in a seated position on the animal's back. Often, the rider loops the end of the hand strap through his/her fingers to prevent the hand strap from slipping out of his/her hand during the ride.

Several problems often arise during the course of the ride. First, riders that loop the hand strap through their fingers can become hung-up on the animal if they are bucked off and the hand strap does not release. These riders are then tossed around, dangling by their trapped hand as the animal continues to buck. This ties into the second problem. In order to stop the animal from bucking, a rodeo hand or clown typically has to manually remove the bucking strap fastened around the hindquarters of the animal. Aside from being a difficult task, it is also very dangerous to attempt to remove the bucking strap from an animal that is thrashing around. There is also a great deal of controversy surrounding the use of bucking straps on animals in this manner.

Therefore, there is a need for a device that allows both the rider's hand strap and the animal's bucking strap to release on demand.

### SUMMARY OF THE INVENTION

A first aspect of the present invention provides a remote controlled bucking system comprising a remote controlled bucking strap and a remote controlled hand strap.

A second aspect of the present invention provides a remote controlled bucking strap comprising a bucking strap and a remote controlled releasing system.

A third aspect of the present invention provides a remote controlled hand strap comprising a hand strap and a remote controlled releasing system.

A fourth aspect of the present invention provides a remote controller for use in conjunction with a remote controlled bucking system comprising at least one release button to release a remote controlled bucking strap.

The foregoing and other features and advantages of the invention will be apparent from the following more particular description of the embodiments of the invention.

### BRIEF DESCRIPTION OF THE DRAWINGS

The embodiments of this invention will be described in detail, with reference to the following figures, wherein like designations denote like elements, and wherein:

FIG. 1 depicts a remote controlled bucking system modeled on a bull;

FIG. 2 depicts a remote controlled bucking strap of the bucking system of FIG. 1;

FIG. 3 depicts a releasing mechanism of the bucking strap of FIG. 2;

FIG. 4 depicts a cross-sectional view of the releasing mechanism of FIG. 3 in a locked position;

FIG. 5 depicts a male connector end of the releasing mechanism of FIG. 4;

FIG. 6 depicts a remote controlled hand strap of the bucking system of FIG. 1;

FIG. 7 depicts a releasing mechanism of the hand strap of FIG. 6;

FIG. 8 depicts a cross-sectional view of the releasing mechanism of FIG. 7 in a locked position;

FIG. 9 depicts a male connector end of the releasing mechanism of FIG. 8;

FIG. 10 depicts a remote controller that controls the remote controlled bucking system;

FIG. 11 depicts a protective case surrounding the releasing system of the bucking strap of FIG. 2; and

FIG. 12 depicts a protective case surrounding the releasing system of the hand strap of FIG. 6.

### DESCRIPTION OF THE PREFERRED EMBODIMENT

Although certain embodiments of the present invention will be shown and described in detail, it should be understood that various changes and modifications might be made without departing from the scope of the appended claims. The scope of the present invention will in no way be limited to the number of constituting components, the materials thereof, the shapes thereof, the relative arrangement thereof, etc. Although the drawings are intended to illustrate the present invention, the drawings are not necessarily drawn to scale.

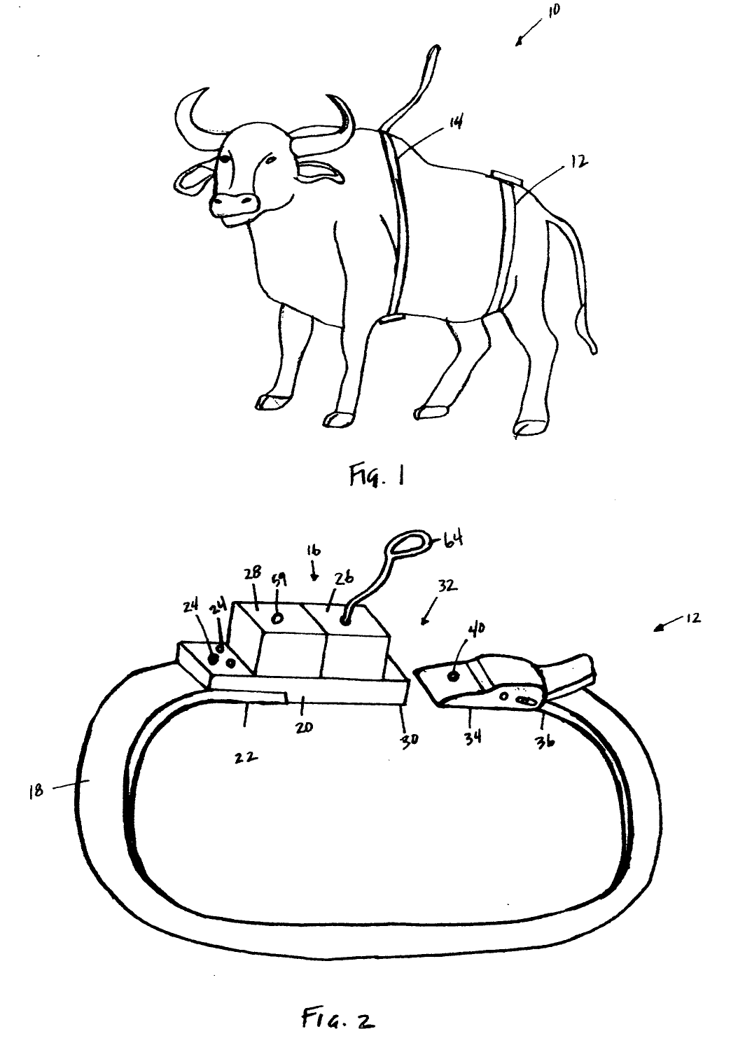

As illustrated in FIG. 1, the present invention provides a remote controlled bucking system 10 that allows a person to release either, or both, a rider's hand strap and/or an animal's bucking strap from a remote location. The remote controlled bucking system 10 includes a remote controlled bucking strap 12 and a remote controlled hand strap 14.

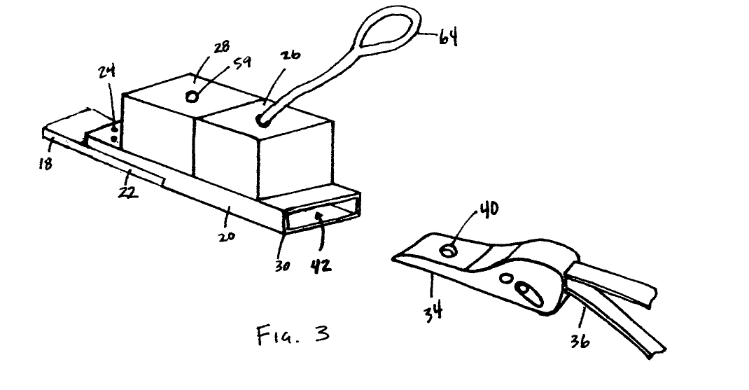

FIG. 2 shows a remote controlled bucking strap 12 in accordance with the present invention. The remote controlled bucking strap 12 includes a releasing system 16 and a strap 18. The strap 18 may comprise leather, rope, nylon, or other similarly used material. The releasing system 16 comprises a base 20 securely connected to a first end 22 of the strap 18, via at least one fastening mechanism 24, i.e., a rivet, or other similarly used device. The present example uses three rivets 24 for purposes of illustration.

The base 20 may comprise metal, plastic, or other similarly used material. A remote control signal receiver 26 and a battery pack 28 are securely fastened to the base 20. The base 20 forms a first end 30 of a releasing mechanism 32. A second end 34 of the releasing mechanism 32 is adjustably connected to a second end 36 of the strap 18.

As illustrated more clearly in FIG. 3, the first end 30 of the releasing mechanism 32 comprises a female connector end, or receiver end, having a cavity 42 that receives the second end, or male connector end 34, of the releasing mechanism 32. The male connector end 34 includes an opening, or hole 40 that secures the male connector end 34 within the receiver end 30.

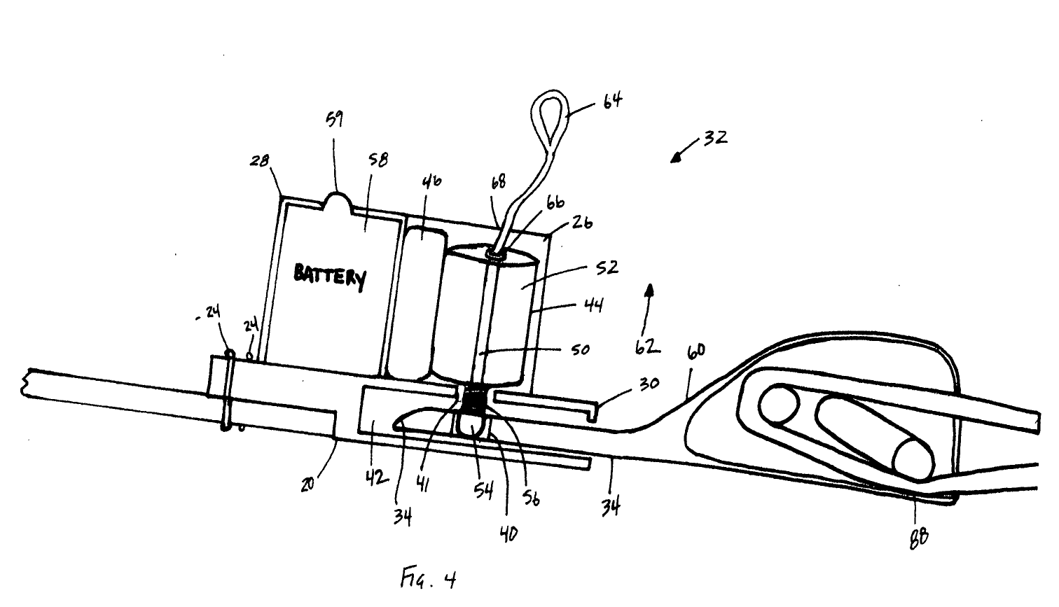

As illustrated in FIG. 4, in a connected or locked position the cavity 42 of the receiver end 30 receives the male connector end 34. The remote control signal receiver 26 contains an electromagnet 44 electronically connected to a micro-processing unit 46. The electromagnet 44 comprises a rod 50 through an opening within a body of cylindrically wound electrically conductive material or wire 52. The rod 50 has a plunger end 54 that extends through an opening 41 within, and into the cavity 42 of, the receiver end 30 of the releasing mechanism 32. A compression spring 56 surrounds the rod 50 at the end of the rod 50 abutting the base of the electromagnet 44 and the top of the plunger end 54. The compression spring 56 holds the plunger end 54 of the electromagnet 44 down in the cavity 42 of the receiver end 30 of the releasing mechanism 32. A battery 58 within the battery pack 28 is electrically connected to the electromagnet 44 as known in the art.

When the male connector end 34 is inserted into the cavity 42 of the receiver end 30, as illustrated in FIG. 4, the plunger end 54 snaps into, and nests within, the opening 40 of the male connector end 34. The contour 60 of the male connector end 34, in particular, the increasing slope 60, helps to prevent the male connector end 34 from being inserted too far into the receiver end 30 of the releasing mechanism 32. The compression spring 56 around the base of the rod 50 prevents the rod 50 and plunger end 54 from moving in the direction of arrow 62 thereby releasing the male connector end 34 from the receiver end 30 of the releasing mechanism 32 and disconnecting the bucking strap 12.

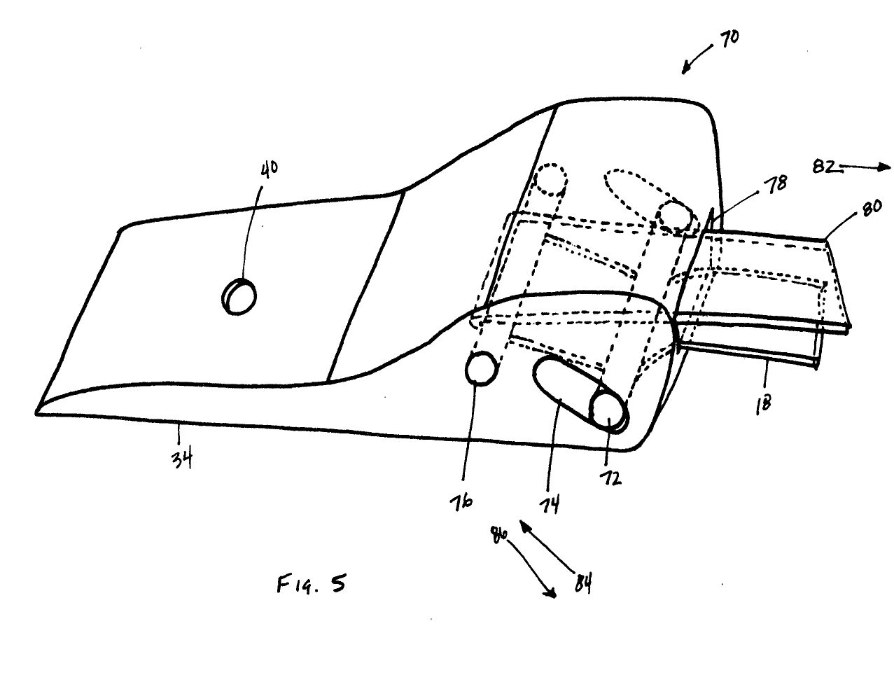

As illustrated in FIG. 5, the male connector end 34 further comprises a strap cinching system 70. The cinch 70 comprises a knurled rod 72 that moves within a slot 74, and a fixed rod 76. The strap 18 enters the cinch 70 of the male connector end 34 through a slot, or opening 78. The strap 18 is fed under the knurled rod 72, around the fixed rod 76 and back out the slot 78.

When the bucking strap 12 is placed around the animal, as illustrated in FIG. 1, the male connector end 34 is inserted into the receiver end 30 of the releasing mechanism 32 (refer to FIG. 4). As illustrated in FIG. 5, a free end 80 of the strap 18 is pulled in the direction of arrow 82 to tighten the bucking strap 12 around the animal. When the free end 80 of the strap 18 is pulled in the direction of arrow 82 the knurled rod 72 rolls upward within the slot 74 in the direction of arrow 84, thereby allowing free movement of the strap 18. When the bucking strap 12 is tight around the animal the free end 80 of the strap 18 is released causing the strap 18 to move in a direction opposite, arrow 82. The knurled rod 72 then rolls downward within the slot 74, in the direction of arrow 86, opposite arrow 84, thereby pinching the strap 18 against the interior 88 of the male connector end 34 (refer to FIG. 4). The strap 18 is then prevented from loosening.

The remote controlled bucking system 10 further comprises a remote controlled hand strap 14. As illustrated in FIGS. 6-9, the remote controlled hand strap 14 is similar to the remote controlled bucking strap 12. As illustrated in FIG. 6, the remote controlled hand strap 14 comprises a releasing system 102 and a strap 100 that releasably fastens around the chest of the animal just behind the front legs of the animal (as shown in FIG. 1). The strap 100 may comprise leather, nylon, rope, or other similarly used material.

The releasing system 102 comprises a base 108 securely connected to a first end 104 of the strap 100, via at least one fastening mechanism 110, i.e., a rivet, or other similarly used device. The present example uses three rivets 110 for purposes of illustration.

The base 108 may comprise metal, plastic, or other similarly used material. A remote control signal receiver 112 and a battery pack 114 are securely fastened to the base 108. The base 108 forms a first end 116 of a releasing mechanism 118. A second end 120 of the releasing mechanism 118 is adjustably connected to a second end 106 of the strap 100.

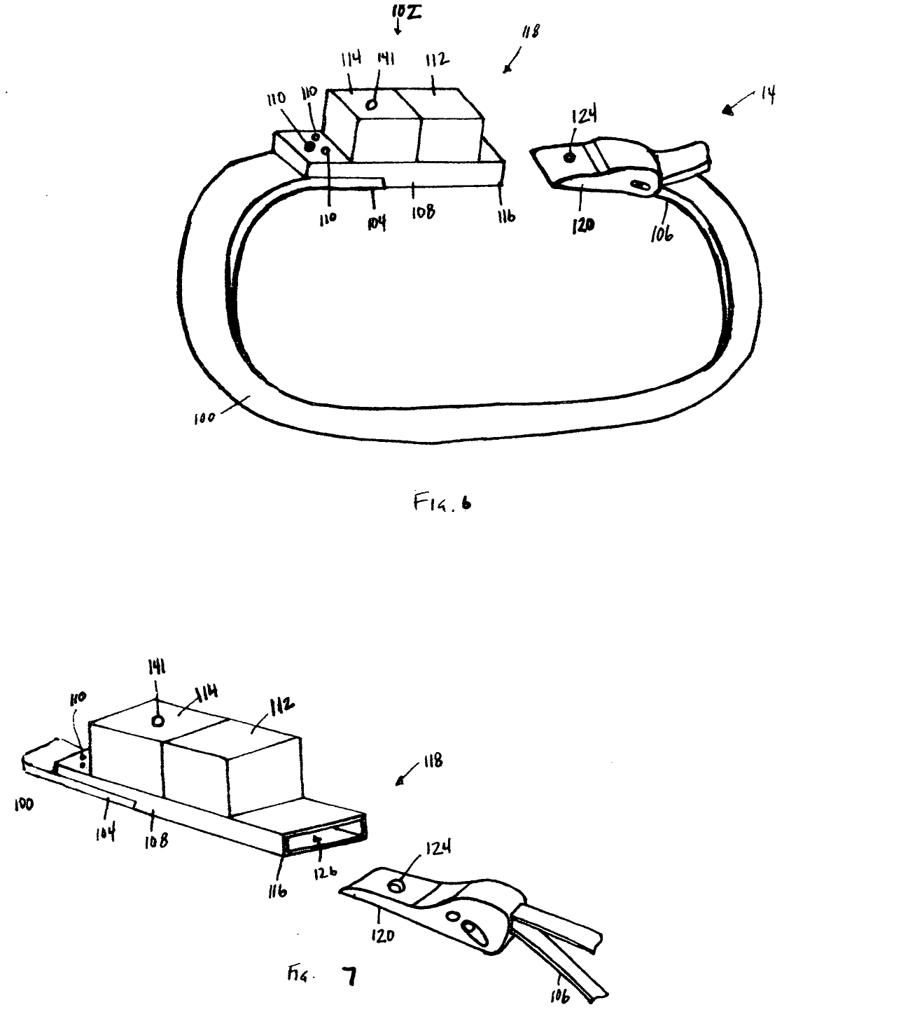

As illustrated more clearly in FIG. 7, the first end 116 of the releasing mechanism 118 comprises a female connector end, or receiver end, having a cavity 126 that receives the second end, or male connector end 120, of the releasing mechanism 118. The male connector end 120 includes an opening, or hole 124 that secures the male connector end 120 within the receiver end 116.

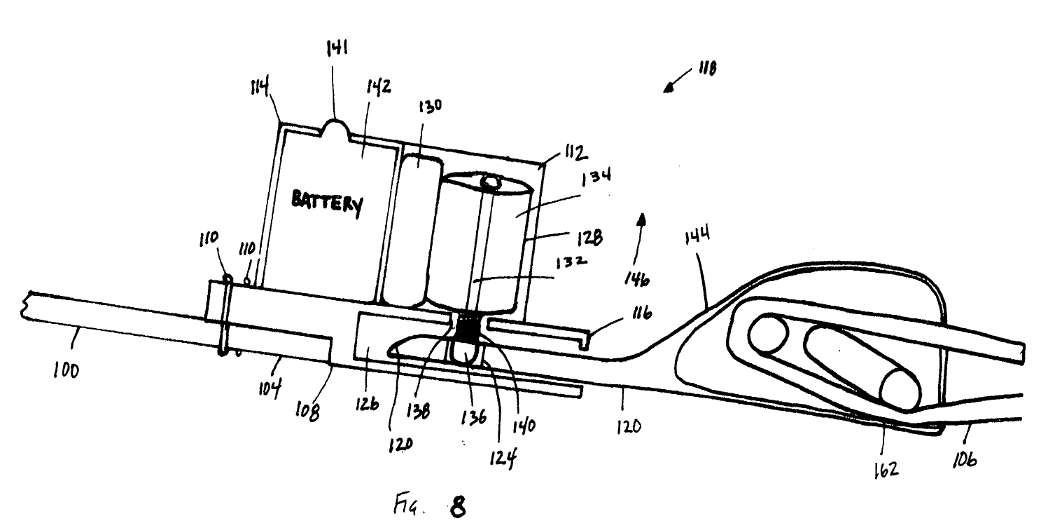

As illustrated in FIG. 8, in a connected or locked position the cavity 126 of the receiver end 116 receives the male connector end 120. The remote control signal receiver 112 contains an electromagnet 128 electronically connected to a micro-processing unit 130. The electromagnet 128 comprises a rod 132 through an opening within a body of cylindrically wound electrically conductive material or wire 134. The rod 132 has a plunger end 136 that extends through an opening 138 within, and into the cavity 126 of, the receiver end 116 of the releasing mechanism 118. A compression spring 140 surrounds the rod 132 at the end of the rod 132 abutting the base of the electromagnet 128 and the top of the plunger end 136. The compression spring 140 holds the plunger end 136 of the electromagnet 128 down in the cavity 126 of the receiver end 116 of the releasing mechanism 118. A battery 142 is electrically connected to the electromagnet 128 as known in the art.

As described with the bucking strap 12, when the male connector end 120 is inserted into the cavity 126 of the receiver end 116, as illustrated in FIG. 8, the plunger end 136 snaps into, and nests within, the opening 124 of the male connector end 120. The contour 144 of the male connector end 120, in particular, the increasing slope 144, helps to prevent the male connector end 120 from being inserted too far into the receiver end 116 of the releasing mechanism 118. The compression spring 140 around the base of the rod 132 prevents the rod 132 and plunger end 136 from moving in the direction of arrow 146 thereby releasing the male connector end 120 from the receiver end 116 of the releasing mechanism 118 and disconnecting the hand strap 14.

As illustrated in FIG. 9, the male connector end 120 further comprises a strap cinching system 149. The cinch 149 comprises a knurled rod 154 that moves within a slot 156, and a fixed rod 155. The strap 100 enters the cinch 149 of the male connector end 120 through a slot, or opening 151. The strap 100 is fed under the knurled rod 154, around the fixed rod 155 and back out the slot 151.

When the hand strap 14 is placed around the animal, as illustrated in FIG. 1, the male connector end 120 is inserted into the receiver end 116 of the releasing mechanism 118 (refer to FIG. 8). As illustrated in FIG. 9, a free end 150 of the strap 100 is pulled in the direction of arrow 152 to tighten the hand strap 14 around the animal. When the free end 150 of the strap 100 is pulled in the direction of arrow 152 the knurled rod 154 rolls upward within the slot 156 in the direction of arrow 158, thereby allowing free movement of the strap 100. When the hand strap 14 is tight around the animal the free end 150 of the strap 100 is released causing the strap 100 to move in a direction opposite arrow 152. The knurled rod 154 then rolls downward within the slot 156, in the direction of arrow 160, opposite arrow 158, thereby pinching the strap 100 against the interior 162 of male connector end 120 (refer to FIG. 8). The strap 100 is then prevented from loosening.

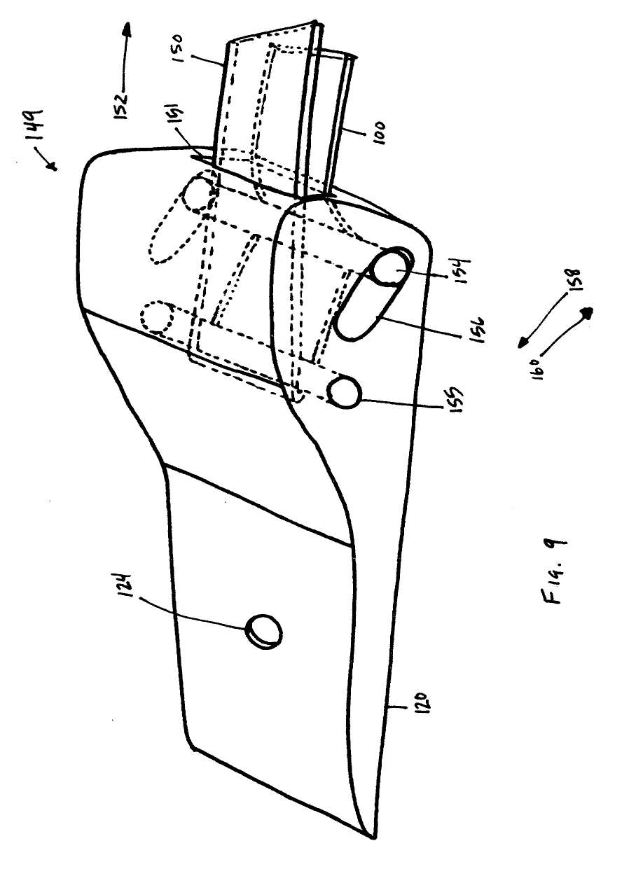

The remote controlled bucking strap 12 and the remote controlled hand strap 14 may be released from a remote location using a remote controller 200, as illustrated in FIG. 10. The remote controller 200 may comprise at least one first release button 202 and at least one second release button 204 on a remote control panel 206. The first release button 202 causes the bucking strap 12 to release and the second release button 204 causes the hand strap 14 to release.

In particular, a signal is sent from the remote controller 200 to the remote control signal receiver 26, 112 affixed to the base 20, 108 of the releasing system 16, 102 (refer to FIGS. 2 and 6, respectively). When the micro-processing unit 46, 130 receives the signal from the remote controller 200 the micro-processing unit 46, 130 causes an electrical circuit (not shown) between the battery 58, 142 and the electromagnet 44, 128 to close. The closed circuit causes an electrical charge to pass through the body 52, 134 of the electromagnet 44, 128, which in turn causes the rod 50, 132 within the electromagnet 44, 128 to move in the direction of arrow 62, 146. The plunger end 54, 136 attached to the end of the rod 50, 132 also moves in the direction of arrow 62, 146 and out of the opening 41, 124 within the male connector end 34, 120 of the releasing mechanism 32, 118, thereby releasing the male connector end 34, 120 from the receiver end 30, 116. Thereby allowing the bucking strap 12 and/or the hand strap 14 to release and fall off the animal.

In this illustration, the remote control panel 206 comprises a pair of release buttons 202, 204 numbered “1”, “2”, “3”, and “4”. This would allow for the use of multiple remote controlled bucking straps 12 and hand straps 14. In particular, each remote controlled bucking strap 12 and hand strap 14 used would operate on a different radio frequency. For example, remote controlled bucking strap “1” would operate on a first frequency and could be released by depressing the first release button 202 below the “1”, remote controlled bucking strap “2” would operate on a second frequency and could be released by the first depressing release button 202 below the “2”, and so on. Similarly, remote controlled hand strap “1” would operate on a first frequency and could be released by depressing the second release button 204 below the “1”, remote controlled hand strap “2” would operate on a second frequency and could be released by depressing release button 204 below the “2”, and so on.

The release buttons 202, 204 may also be color coded as illustrated. In the present example, the release buttons 202, 204 “1” correspond with “RED”, the release buttons 202, 204 “2” correspond with “BLUE”, the release buttons 202, 204 “3” correspond with “WHITE”, and the release buttons 202, 204 “4” correspond with “YELLOW”. The color of the release button can be coordinated with the shoot holding the animal and rider, the bucking strap 12 around the hindquarters of the animal, the hand strap 14 used by the rider, etc.

The remote control panel 206 may also comprise a timer 208 to indicate when the designated time is up for each rider, for example, 8 seconds for bull riders, etc. When the timer 208 reads 00:00 time remaining an operating individual will know it is time to depress the release buttons 202, 204. The remote control panel 206 may comprises a time setting device 210 to allow for adjustment to accommodate different time periods as desired. The timer 208 may begin either manually at the control panel 206, or automatically when the animal breaks the plane of the shoot as the animal and rider exit the shoot. The remote control panel 206 further comprises a horn 212 that will automatically sound at the end of the designated time period. This will also alert the individual depressing the release button 202, 204 that it is time to depress the release button 202, 204.

Alternatively, it may be preferable to have the remote controller 200 programmed to automatically release the bucking strap 12 when the timer.208 registers 00:00 ride time remaining, and/or when the horn 212 signals the end of the ride.

The remote control panel 206 may also comprise an emergency override release button 214. The emergency override release button 214 releases both the remote controlled bucking strap 12 and the rider's remote controlled hand strap 14 in the event the release button 202, 204, or automatic release malfunctions.

Alternatively, in an emergency the bucking strap 12 may be released manually. In particular, a releasing strap 64 is fixedly mounted to a top end 66 of the rod 50 of the electromagnet 44 and extends through an opening 68 within the remote control signal receiver 26. When the releasing strap 64 is pulled the rod 50 is forced in the direction of arrow 62, thereby forcing the plunger end 54 attached to the end of the rod 50 to move in the direction of arrow 62 and out of the opening 40 within the male connector end 34 of the releasing mechanism 34. Accordingly, the male connector end 34 is released from the receiver end 30 and the bucking strap 12 falls off the animal.

The battery 58, 142 affixed to the base 20, 108 of the remote controlled bucking strap 12 and the remote controlled hand strap 14, respectively, may be removable and rechargeable. Multiple rechargeable batteries 58, 142 can be available in the event a replacement is required. The rechargeable battery 58, 142 may have an indicator light 59, 141 on a top surface of the battery 58, 142 to indicate the battery 58, 142 has sufficient charge. For example, a green light would mean a sufficiently charged battery 58, 142 while a red light would indicate a battery 58, 142 in need of charging. This would limit any error resulting from battery 58, 142 failure.

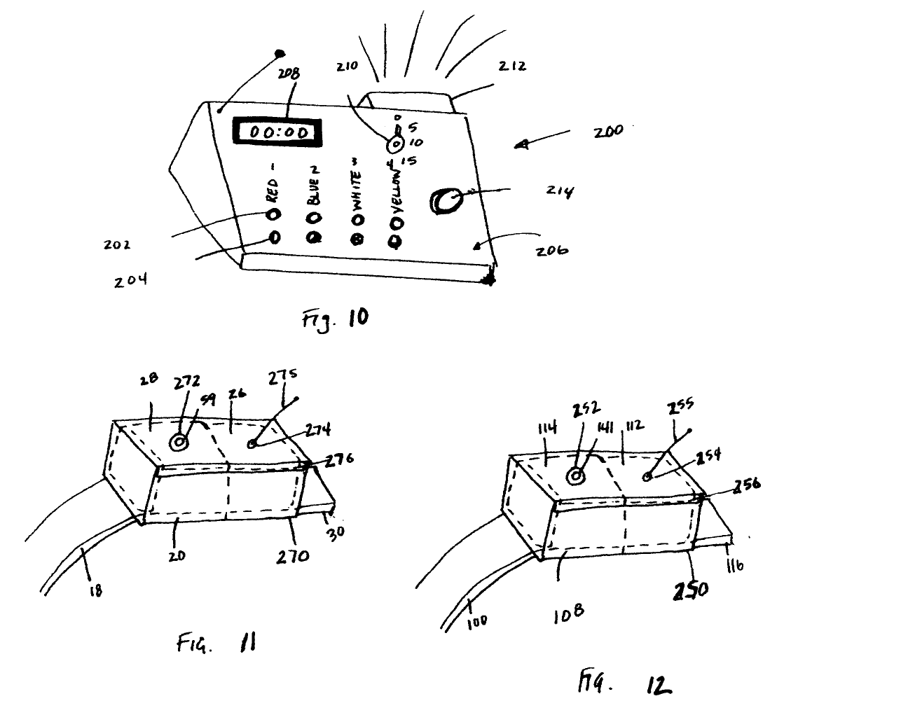

As illustrated in FIGS. 11 and 12, the remote controlled bucking strap 12 and remote controlled hand strap 14 may also comprise a case 270, 250, surrounding the base 20, 108, battery pack 28, 114 and remote control signal receiver 26, 112 to prevent inadvertent damage during use. The case 270, 250 may be formed of leather, plastic or other similarly used material. The case 270, 250 may comprise a first opening 272, 252 to allow for visual inspection of the battery indicator light 59, 141. A second opening 274, 254 in the case 270, 250 may be needed to accommodate an antenna 275, 255 for the remote control signal receiver 26, 112. The case 270, 250 may be releasably secured around the base 20, 108, battery pack 28, 114 and remote control signal receiver 26, 112 using snaps, Velcro™, etc., on a flap 276, 256 to allow access to the battery pack 28, 114 and/or remote control signal receiver 26, 112 as necessary. The case 270, 250 may be color coded to match the color of the bucking strap 12 and/or hand strap 14 being used therewith.

It should be noted that it is not necessary to use both the bucking strap 12 and the hand strap 14 together in combination. For example, when riding a bucking horse, as opposed to a bull, the hand strap 14 may not be used.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A remote controlled bucking system comprising:
a remote controlled bucking strap; and
a remote controlled hand strap.

2. The system of claim 1, wherein the remote controlled bucking strap further comprises:
a releasing system comprising:
a base securely fastened at a first end of the bucking strap;
a battery mounted on the base; and
a remote control signal receiver mounted on the base.

3. The system of claim 2, wherein the releasing system of the bucking strap further comprises:
a first connector end within the base; and
a second connector end affixed to a second end of the bucking strap, wherein the second connector end is releasably connectable within the first connector end.

4. The system of claim 2, wherein the remote control signal receiver further comprises:
an electromagnet; and
a micro-processing unit.

5. The system of claim 4, wherein the electromagnet further comprises:
a body of cylindrically wound electrically conductive material having a hole therethrough;
a rod slidably mounted within the hole through the body of cylindrically wound electrically conductive material; and
a plunger end affixed to an end of the rod.

6. The system of claim 5, wherein the second connector end further comprises an opening within which the plunger end of the electromagnet within the first connector end nests upon connection of the first and second connector ends.

7. The system of claim 1, wherein the bucking strap further comprises a manual release strap.

8. The system of claim 1, wherein the remote controlled hand strap further comprises:
a releasing system comprising:
a base securely fastened at a first end of the hand strap;
a battery mounted on the base; and
a remote control signal receiver mounted on the base.

9. The system of claim 8, wherein the releasing system of the hand strap further comprises:
a first connector end within the base; and
a second connector end affixed to a second end of the hand strap, wherein the second connector end is releasably connectable within the first connector end.

10. The system of claim 9, wherein the second connector end further comprises:
an electromagnet; and
a micro-processing unit.

11. The system of claim 10, wherein the electromagnet further comprises:
a body of cylindrically wound electrically conductive material having a hole therethrough;
a rod slidably mounted within the hole through the body of cylindrically wound electrically conductive material; and
a plunger end affixed to an end of the rod.

12. The system of claim 11, wherein the second connector end further comprises an opening within which the plunger end of the electromagnet within the first connector end nests upon connection of the first and second connector ends.

13. The system of claim 1, further comprising a remote controller comprising:
at least one release button to release the bucking strap; and
at least one release button to release the hand strap.

14. The system of claim 13, wherein the remote controller is programmed to automatically release the bucking strap at the end of a designated time period.

15. A remote controlled bucking strap comprising:
a bucking strap; and
a remote controlled releasing system.

16. The bucking strap of claim 15, wherein the remote controlled bucking strap further comprises:
a releasing system comprising:
a base securely fastened at a first end of the bucking strap;
a battery mounted on the base; and
a remote control signal receiver mounted on the base.

17. The bucking strap of claim 16, wherein the releasing system of the bucking strap further comprises:
a first connector end within the base; and
a second connector end affixed to a second end of the bucking strap, wherein the second connector end is releasably connectable within the first connector end.

18. The bucking strap of claim 17, wherein the second connector end further comprises:
an electromagnet; and
a micro-processing unit.

19. The bucking strap of claim 18, wherein the electromagnet further comprises:
a body of cylindrically wound electrically conductive material having a hole therethrough;
a rod slidably mounted within the hole through the body of cylindrically wound electrically conductive material; and
a plunger end affixed to an end of the rod.

20. The bucking strap of claim 19, wherein the second connector end further comprises an opening within which the plunger end of the electromagnet within the first connector end nests upon connection of the first and second connector ends.

21. The bucking strap of claim 15, wherein the bucking strap further comprises a manual release strap.

22. A remote controlled hand strap comprising:
a hand strap; and
a remote controlled releasing system.

23. The hand strap of claim 22, wherein the remote controlled hand strap further comprises:
a releasing system comprising:
a base securely fastened at a first end of the hand strap;
a battery mounted on the base; and
a remote control signal receiver mounted on the base.

24. The hand strap of claim 23, wherein the releasing system of the hand strap further comprises:
a first connector end within the base; and
a second connector end affixed to a second end of the bucking strap, wherein the second connector end is releasably connectable within the first connector end.

25. The hand strap of claim 24, wherein the second connector end further comprises:
an electromagnet; and
a micro-processing unit.

26. The hand strap of claim 25, wherein the electromagnet further comprises:
a body of cylindrically wound electrically conductive material having a hole therethrough;
a rod slidably mounted within the hole through the body of cylindrically wound electrically conductive material; and
a plunger end affixed to an end of the rod.

27. The hand strap of claim 26, wherein the second connector end further comprises an opening within which the plunger end of the electromagnet within the first connector end nests upon connection of the first and second connector ends.

28. A remote controller for use in conjunction with a remote controlled bucking system comprising:
at least one release button to release a remote controlled bucking strap.

29. The remote controller of claim 28, further comprising:
at least one release button to release a remote controlled hand strap.

30. The remote controller of claim 28, further comprising:
a timer; and
a horn.

31. The remote controller of claim 28, wherein the controller is programmed to automatically release the bucking strap at the end of a designated time period.

32. The remote controller of claim 28, further comprising:
an emergency release button to release a hand strap and a bucking strap.
